(19) United States
(12) Patent Application Publication
(10) Pub. No.: US 2004/0251043 A1
(43) Pub. Date: Dec. 16, 2004

(54) Modular gangable switch box

(76) Inventor: Charles N. Chung, South El Monte, CA (US)

Correspondence Address: Raymond Y. Chan, Suite 128, 108 N. Ynez Ave., Monterey Park, CA, 91754, US

(21) Appl. No.: 10/868,569

(22) Filed: Jun. 14, 2004

Related U.S. Application Data
(60) Provisional application No. 60/478,092, filed on Jun. 13, 2003.

(51) Int. Cl. H02G 3/08

(52) U.S. Cl. 174/50

(57) ABSTRACT

A modular gangable switch box is selectively formed by at least a box modular, wherein each box modular includes an upper panel and a lower panel to define a socket therebetween for receiving a switch assembly in the socket. A side locker is provided on each side end of the upper and lower panels of the box modular for connecting with another box modular in such a manner that the switch box having a desired number of sockets is capable of being formed by selectively connecting the box modulars together.

### CROSS REFERENCE OF RELATED APPLICATION

This is a Regular Application of a provisional application, application No. 60/478,092, filed Jun. 13, 2003.

### BACKGROUND OF THE PRESENT INVENTION

1. Field of Invention

The present invention relates to a switch box, and more particularly to a modular gangable switch box, wherein the switch box having a predetermined size is capable of selectively connecting with another switch box to form an optimum size of the combination of the switch boxes for use.

2. Description of Related Arts

Conventionally, there are two types of a switch box for receiving a switch assembly therein, which are an exterior switch box mounted on a wall and an interior switch box hiddenly mounted behind the wall. However, there are several drawbacks of the conventional switch box. No matter which type of switch box is used, the conventional switch box has a predetermined socket size to receive a predetermined number of switch assemblies. In other words, when ten switch assemblies are needed, a ten-socket size of switch assembly must be used. So, a user must clearly determine the socket size of the switch box that will be used before the construction. If the user purchases a wrong size of the switch box, the switch box will not be fitted into the switch box, which is a waste of source and highly increases the cost of construction.

Furthermore, the switch box must be mounted on a supporting frame by means of bolts in order to provide a firm and rigid support of the switch box. Since the supporting frame is built during construction, which cannot re-model later, the size of the switch box may not fittedly mount on the supporting frame. The misconnection of the switch box to the supporting frame will cause over screwing the bolts, which will damage the supporting frame as well.

In addition, the storage and carriage of the switch box is one of the major drawbacks. Because of the various sizes of the switch box, the manufacturer must keep all sizes of the switch boxes in the store as the inventory, which occupies lots of space especially the bigger size of the switch boxes.

For manufacturing the switch box, a huge molding machine is needed especially for the larger size of the switch box. Since the switch box need not to have an aesthetic appearance but the firm and rigid structure, a relatively great pressing force must applied on a plain metal sheet by the molding machine in order to form the shape of the switch box. However, the cost of manufacturing the switch box is high because of the costly of the molding machine and its maintenance.

### SUMMARY OF THE PRESENT INVENTION

A main object of the present invention is to provide a modular gangable switch box, wherein each modular having a predetermined socket is adapted for selectively connecting with another modular to form a desired size of switch box.

Another object of the present invention is to provide a modular gangable switch box, wherein each modular comprises two side lockers for securely locking with another modular, so as to provide a firm and rigid structure of the switch box.

Another object of the present invention is to provide a modular gangable switch box, wherein the switch box comprises a connecting means for adjustably mounting on different thickness of the wall, so as to prevent over screwing on the wall.

Another object of the present invention is to provide a modular gangable switch box, wherein the manufacturer merely manufactures three sizes of the modular to selectively form any size of the switch box, which can reduce the space for storage and ease of carriage.

Another object of the present invention is to provide a modular gangable switch box, wherein the manufacturing cost of the modular is simple and relatively low since each modular can be manufactured by a small molding machine instead of a huge molding machine.

Accordingly, in order to accomplish the above objects, the present invention provides a modular gangable switch box comprising at least a box modular, wherein the box modular comprises an upper panel and a lower panel to define a predetermined socket therebetween wherein each socket is adapted for receiving a switch assembly therein, a side locker provided on each side of the box modular for rigidly connecting with another box modular, and a connecting means for securely connecting the switch box on a supporting surface.

### BRIEF DESCRIPTION OF THE DRAWINGS

FIG. 1 is a perspective view of a conventional switch box.

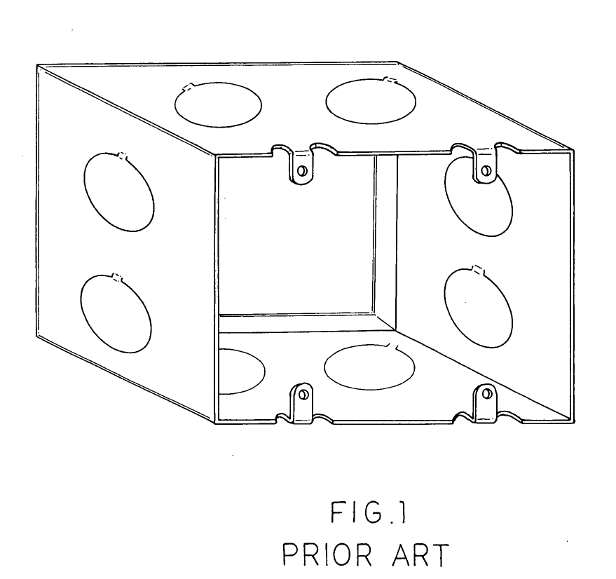

FIG. 2 is a perspective view of a modular gangable switch box according to a preferred embodiment of the present invention.

FIG. 3 is a perspective view of the modular gangable switch box formed by a one-socket box modular, a two-socket box modular, and a three-socket box modular according to the above preferred embodiment of the present invention.

FIG. 4 illustrates a connection between two modular gangable switch boxes according to the above preferred embodiment of the present invention.

FIG. 5 is a perspective view of an end plane of the modular gangable switch box according to the above preferred embodiment of the present invention.

FIG. 6 is a perspective view of the modular gangable switch box mounted on a wall according to the above preferred embodiment of the present invention.

### DETAILED DESCRIPTION OF THE PREFERRED EMBODIMENT

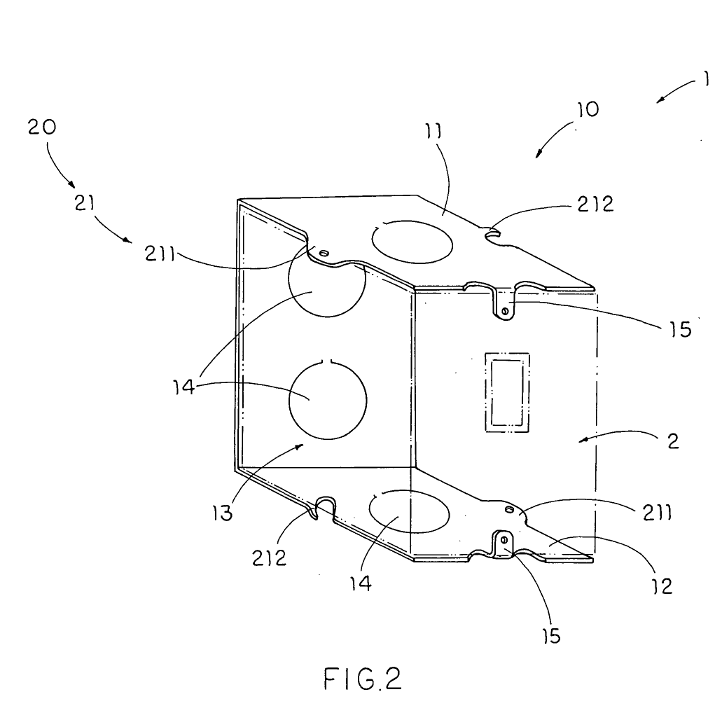

Referring to FIG. 2 of the drawings, a modular gangable switch box 1 according to a preferred embodiment of the present invention is illustrated, wherein the switch box 1 comprises at least a box modular 10 to form the switch box 1. Each box modular 10 having a U-shaped cross section comprises an upper wall 11 and a lower wall 12 to define a socket 13 therein wherein each socket 13 is adapted for receiving a switch assembly 2 therein. Each box modular 10 is adapted for rigidly connecting with another box modular 10 to form a desired size of the switch box 1.

Each box modular 10 further comprises a plurality of detachable plates 14 spacedly connected thereto wherein the detachable plates 14 are adapted for detaching from the box modular 10 in order to communicate the socket 13 with an exterior of the box modular 10. At least a pair of locking lips 15 are opposedly and integrally extended from edges of the upper panel 11 and the lower panel 12 of the box modular 10 respectively for securely locking the switch assembly 2 on the box modular 10.

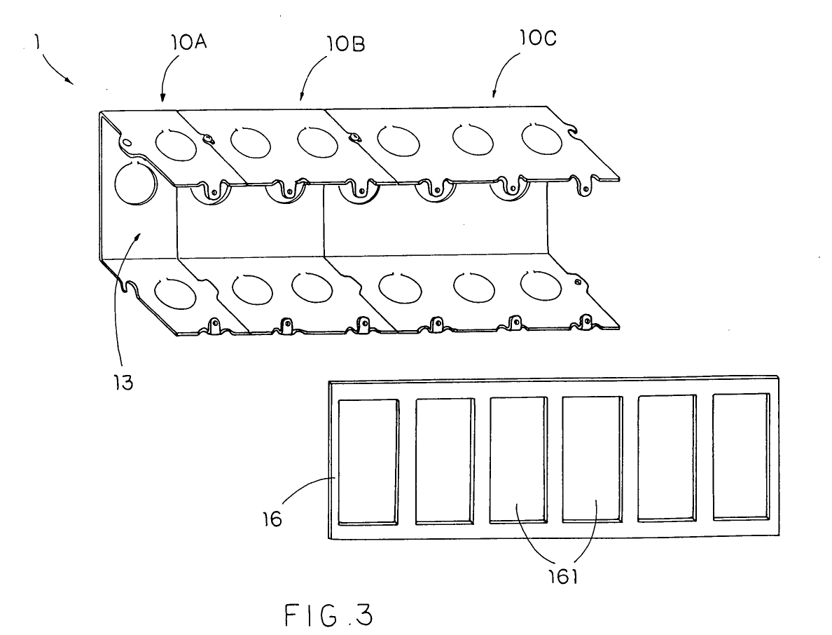

According to the preferred embodiment, each box modular 10 has a predetermined socket 13 provided therein. Preferably, there are three types of box modular 10A, 10B, 10C, which is a one-socket box modular 10A having one socket 13A provided therein for receiving one switch assembly 2 therein, a two-socket box modular 10B having two sockets 13B provided therein for receiving two switch assemblies 2 therein, and a three-socket box modular 10C having three sockets 13C provided therein for receiving three switch assemblies 2 therein. The three types of box modular 10A, 10B, 10C are adapted for selectively connecting with each other to form a combination of the switch box 1 having predetermined sockets 13. For example, a switch box 1 can be formed by a one-socket box modular 10A, a two-socket box modular 10B, and a three-socket box modulars 10C for six switch assemblies 2 to be installed into the switch box 1, as shown in FIG. 3. Or, three two-socket box modulars 10B can also be connected together to form a same dimension of the switch box 1, having six sockets 13 for receiving six switch assemblies 1 therein. Therefore, the one-socket box modular 10A, the two-socket box modular 10B, and the three-socket box modular 10C are adapted for selectively connecting each other to form any size of the switch box 1 conveniently.

The box modular 10 further comprises a side locker 20 provided on each side of the modular 1 for rigidly connecting with another box modular 1o, and a connecting means 30 for securely connecting the switch box 1 on a supporting surface S.

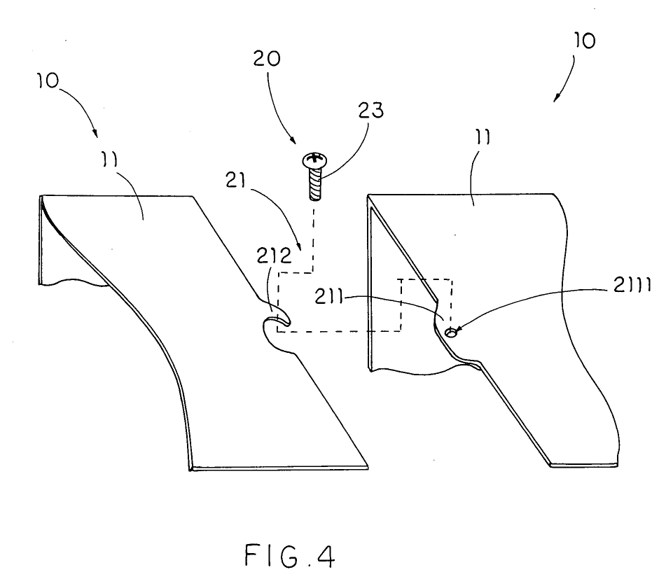

As shown in FIG. 2, the side locker 20 comprises two pairs of corresponding locking members 21 outwardly formed on two side ends of the upper panel 11 and two side ends of the lower panel 12 respectively, wherein each pair of locking members 21 comprises a locking arm 211 and a locking hook 212 adapted for rigidly locking with the locking arm 211. Accordingly, the locking arm 211 has a locking through hole 2111 vertically formed thereon integrally extended from one side end of the upper panel 11 and the opposed side end of the lower panel 12 respectively and the locking hook 212 integrally formed on the other side ends of the upper panel 11 and the lower panel 12 respectively wherein a locking bolt 23 is adapted for securely locking the locking hook 212 with the locking arm 211 through the locking through hole 2111, so as to rigidly connecting two box modulars 10 together, as shown in FIG. 4.

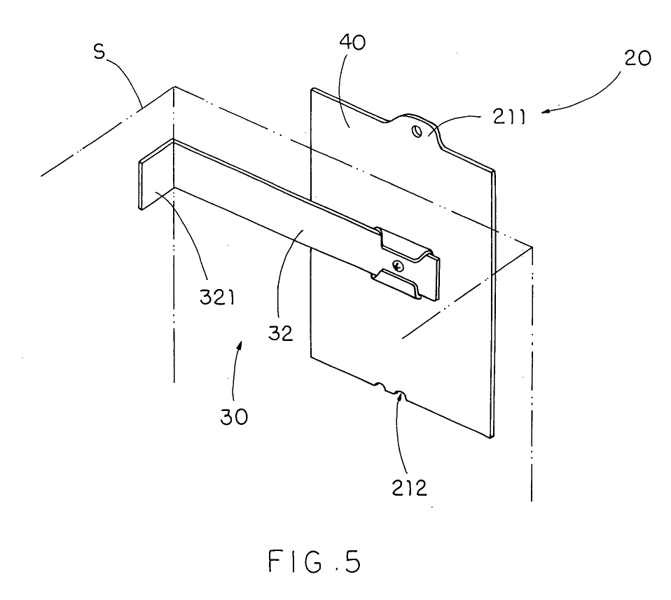

Referring to FIG. 5, the switch box 1 further comprises an end plane 40 detachably connected with each side end of the switch box 1 wherein the end panel 40 comprises the locking arm 211 and the locking hook 212 of the side locker 20 provided on a top and bottom end thereof respectively in order to rigidly connect to the switch box 1, so as to cover the side of the switch box to protect the switch assembly 2 from being damage.

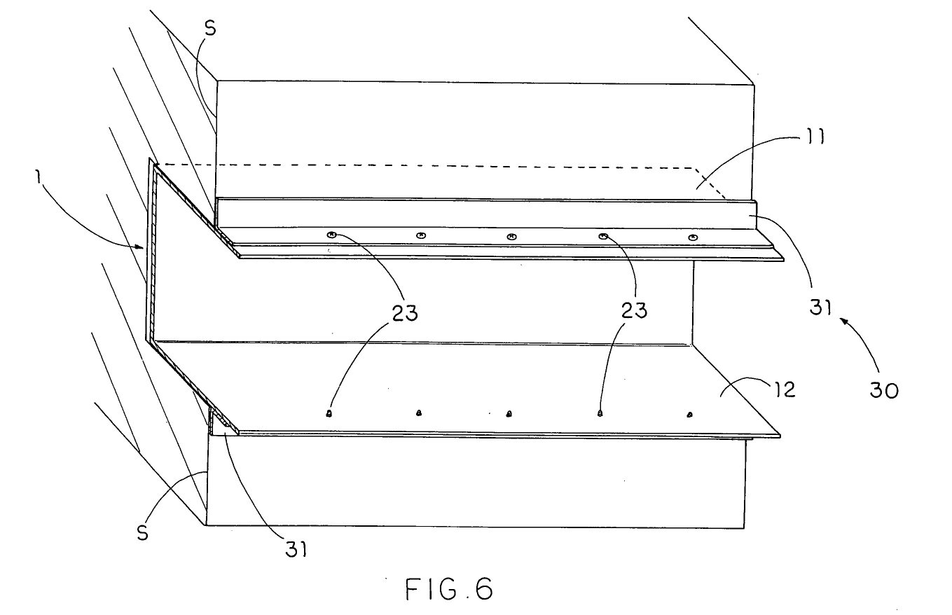

As shown in FIG. 6, the switch box 1 is adapted for securely on the supporting surface S which is the wall. The connecting means 30 comprises a pair of connecting bars 31 having a L-shaped cross section longitudinally attached to outer surfaces of the upper panel 11 and the lower panel 12 respectively. The connecting bar 31 is securely connected to the upper panel 11 and the lower panel 12 by means of the locking bolts 23 penetrated therethrough. So, the switch box 1 is adapted for fittedly embedded into the wall (supporting surface S) while the connecting bars 31 are rigidly biased against the wall, as shown in FIG. 6.

Alternatively, when switch box 1 is mounted on supporting frame (supporting surface S), the connecting means 30 further comprises a pair of L-shaped connecting arms 32 having a locking tip 321 rearwardly extended from the end planes 40 wherein the locking tip 321 is adapted for pressing on a rear surface of the supporting frame S, so as to holding the switch box 1 on the supporting frame S in position, as shown in FIG. 5. Each connecting arm 32 is adjustably attached to the end plane 40 in such a manner that the connecting arm 32 is adapted for selectively adjusting a length thereof extended rearwardly to fit different thickness of the supporting frame S. In other words, by adjusting the rearwardly extended length of the connecting arm 32, the locking tip 321 can fittedly biased against the rear surface of the supporting frame S.

It is worth to mention that the connecting arms 32 are adapted for holding the switch box 1 on the supporting frame S in position which can minimize the bolts screwing on the supporting frame S, so as to damage the structure of the supporting frame and prevent the bolts from being over screwing. Thus, the connecting means 30 can evenly distribute the weight of the switch box 1 on the supporting surface S.

As shown in FIG. 3, the switch box 1 further comprises a box cover 16 detachably mounted in front of the switch box 1 for covering the socket 13, so as to protect the switch assembly 2 therein. The box cover 16 has at least a window 161 to communicate the socket 13 to the exterior of the switch box 1. Preferably, the box cover 16 is used for the switch box 1 having at least five sockets 13 in such a manner the box cover 16 can also provide a rigid support for the switch box 1 as well.

Since the box modular 10 has relatively small size, which has maximum three sockets 13 only, the box modular 10 does not require a conventional huge molding machine. A smaller size of molding machine can mass-produce the box modular 10 into three types as mentioned above. So, the manufacturing cost of the box modular 10 and the maintenance cost of the molding machine can be reduced. Also, the storage and carriage of the box modular 10 is easy because of the small size of box modular 10, which occupy less storage space as well.

What is claimed is:

1. A modular gangable switch box, comprising:
at least a box modular comprising an upper panel and a lower panel to define a predetermined number of sockets therebetween wherein each socket is adapted for receiving a switch assembly therein, a side locker provided on each side of said box modular for rigidly connecting with another said box modular, and a connecting means for securely connecting said switch box on a supporting surface.

2. A modular gangable switch box, as recited in claim 1, wherein said side locker comprises two pairs of corresponding locking members outwardly formed on two side ends of said upper panel and two side ends of said lower panel respectively, wherein each pair of said locking members comprises a locking arm and a locking hook adapted for rigidly locking with said locking arm.

3. A modular gangable switch box, as recited in claim 2, wherein said locking arm having a locking through hole vertically formed thereon is integrally extended from one side end of said upper panel and an opposed side end of said lower panel respectively and said locking hook is integrally formed on said other side ends of said upper panel and said lower panel respectively wherein a locking bolt is adapted for securely locking said locking hook with said locking arm through said locking through hole, so as to rigidly connecting two box modulars together.

4. A modular gangable switch box, as recited in claim 1, further comprising an end panel detachably connected with each side end of said switch box wherein said end panel comprises said side locker in order to rigidly connect to said switch box.

5. A modular gangable switch box, as recited in claim 2, further comprising an end panel detachably connected with each side end of said switch box wherein said end panel comprises said side locker in order to rigidly connect to said switch box.

6. A modular gangable switch box, as recited in claim 3, further comprising an end panel detachably connected with each side end of said switch box wherein said end panel comprises said side locker in order to rigidly connect to said switch box.

7. A modular gangable switch box, as recited in claim 1, wherein said connecting means comprises a pair of connecting bars having a L-shaped cross section longitudinally attached to outer surfaces of said upper panel and said lower panel respectively by means of locking bolts penetrated therethrough in such a manner that said switch box is adapted for fittedly embedded into said supporting surface while said connecting bars are rigidly biased against said supporting surface.

8. A modular gangable switch box, as recited in claim 2, wherein said connecting means comprises a pair of connecting bars having a L-shaped cross section longitudinally attached to outer surfaces of said upper panel and said lower panel respectively by means of locking bolts penetrated therethrough in such a manner that said switch box is adapted for fittedly embedded into said supporting surface while said connecting bars are rigidly biased against said supporting surface.

9. A modular gangable switch box, as recited in claim 3, wherein said connecting means comprises a pair of connecting bars having a L-shaped cross section longitudinally attached to outer surfaces of said upper panel and said lower panel respectively by means of locking bolts penetrated therethrough in such a manner that said switch box is adapted for fittedly embedded into said supporting surface while said connecting bars are rigidly biased against said supporting surface.

10. A modular gangable switch box, as recited in claim 4, wherein said connecting means comprises a pair of connecting bars having a L-shaped cross section longitudinally attached to outer surfaces of said upper panel and said lower panel respectively by means of locking bolts penetrated therethrough in such a manner that said switch box is adapted for fittedly embedded into said supporting surface while said connecting bars are rigidly biased against said supporting surface.

11. A modular gangable switch box, as recited in claim 6, wherein said connecting means comprises a pair of connecting bars having a L-shaped cross section longitudinally attached to outer surfaces of said upper panel and said lower panel respectively by means of locking bolts penetrated therethrough in such a manner that said switch box is adapted for fittedly embedded into said supporting surface while said connecting bars are rigidly biased against said supporting surface.

12. A modular gangable switch box, as recited in claim 4, wherein said connecting means further comprises a pair of L-shaped connecting arms having a locking tip rearwardly extended from the end planes wherein the locking tip is adapted for adjustably pressing on a rear surface of said supporting surface, so as to holding said switch box on said supporting surface in position.

13. A modular gangable switch box, as recited in claim 6, wherein said connecting means further comprises a pair of L-shaped connecting arms having a locking tip rearwardly extended from the end planes wherein the locking tip is adapted for adjustably pressing on a rear surface of said supporting surface, so as to holding said switch box on said supporting surface in position.

14. A modular gangable switch box, as recited in claim 10, wherein said connecting means further comprises a pair of L-shaped connecting arms having a locking tip rearwardly extended from the end planes wherein the locking tip is adapted for adjustably pressing on a rear surface of said supporting surface, so as to holding said switch box on said supporting surface in position.

15. A modular gangable switch box, as recited in claim 11, wherein said connecting means further comprises a pair of L-shaped connecting arms having a locking tip rearwardly extended from the end planes wherein the locking tip is adapted for adjustably pressing on a rear surface of said supporting surface, so as to holding said switch box on said supporting surface in position.

16. A modular gangable switch box, as recited in claim 1, further comprising a plurality of detachable plates spacedly connected on said box modular to communicate said socket with an exterior of said box modular when said detachable plate is detached, and at least a pair of locking lips opposedly and integrally extended from edges of said upper panel and said lower panel of said box modular respectively for securely locking said switch assembly on said box modular.

17. A modular gangable switch box, as recited in claim 6, further comprising a plurality of detachable plates spacedly connected on said box modular to communicate said socket with an exterior of said box modular when said detachable plate is detached, and at least a pair of locking lips opposedly and integrally extended from edges of said upper panel and said lower panel of said box modular respectively for securely locking said switch assembly on said box modular.

18. A modular gangable switch box, as recited in claim 15, further comprising a plurality of detachable plates spacedly connected on said box modular to communicate said socket with an exterior of said box modular when said detachable plate is detached, and at least a pair of locking lips opposedly and integrally extended from edges of said upper panel and said lower panel of said box modular respectively for securely locking said switch assembly on said box modular.

19. A modular gangable switch box, as recited in claim 1, further comprising a box cover detachably mounted in front of said switch box for covering said socket, so as to protect said switch assembly therein, wherein said box cover has at least a window to communicate said socket to an exterior of said switch box.

20. A modular gangable switch box, as recited in claim 18, further comprising a box cover detachably mounted in front of said switch box for covering said socket, so as to protect said switch assembly therein, wherein said box cover has at least a window to communicate said socket to an exterior of said switch box.
